(19) United States
(12) Patent Application Publication
(10) Pub. No.: US 2002/0198613 A1
(43) Pub. Date: Dec. 26, 2002

(54) Radiation controlling sound system

(76) Inventor: Hsienchung Chang, Taipei (TW)

Correspondence Address: BACON & THOMAS, PLLC, 625 SLATERS LANE, FOURTH FLOOR, ALEXANDRIA, VA, 22314

(21) Appl. No.: 09/885,954

(22) Filed: Jun. 22, 2001

(51) Int. Cl. G06F 17/00

(52) U.S. Cl. 700/94

(57) ABSTRACT

The present invention relates to a radiation controlling sound system mainly used during exhibition visits. The present invention mainly consists of a radiation projector for code projecting, a radiation receiver as well as an automatic sound system for receiving codes, and a recording system for recording of different codes. Hence, the present invention is very convenient for exhibition visits as visitors can immediately listen to voice explanation while looking at an object.

### TECHNICAL RANGE

The present invention relates to a controlling sound system mainly used during exhibition visits.

### INVENTION BACKGROUND

Art galleries and museums usually have description or explanation of exposed articles written at the side which is sometimes much inconvenient to read. In order to improve this drawback, the present invention uses radiation to control a sound voice system such that visitors can listen to related information by simply carrying specially designed radiation receiver and automatic sound system. The radiation receiver receives related code at each exposed article and conducts sound voice to earphones such that visitors can easily listen to explanations while going around.

### SUMMARY OF INVENTION

The present invention release to a kind of radiation controlling voice system wherein the receiver as well as the sound emitter part is carried along by the visitor without, however, causing any inconvenience since it is small in volume and very light.

The present invention relates to a kind of radiation controlling voice system wherein the radiation projector is found around exposed articles and can use batteries for power, thus avoiding problem of electric wiring.

The present invention relates to a kind of radiation controlling voice system where the recording system can be recorded with music in the background to increase effectiveness.

### DESCRIPTION OF DRAWING

FIG. 1 shows a plan of the present invention.

FIG. 2 shows the position of the radiation projector.

### NUMERRICAL

10—present invention

11—radiation projector

12—radiation receiver and automatic sound system

13—recording system

1101—direct dialing button

1102—coder

1103—radiation projector

1201—single chip

1202—sound IC

1203—radiation receiver

1204—decoder

1205—earphone

1301—PC

1302—interface card

1303—sound card

14—drawing

15—visitor

### MODE FOR CARRYING OUT INVENTION

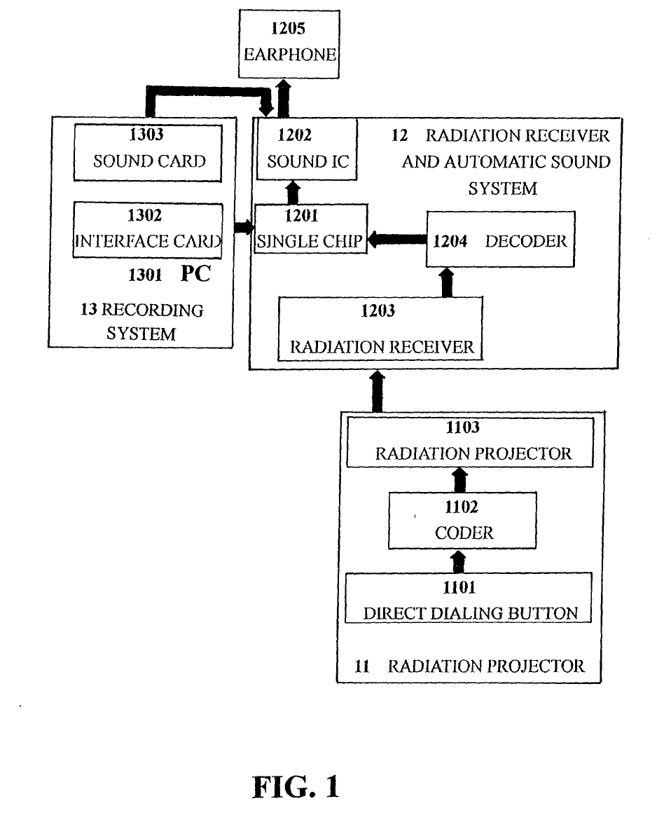

With reference to FIG. 1 showing a plan of the present invention, said invention system 10 mainly consists of three section namely a radiation projector 11, a radiation receiver and automatic sound system 12, and a recording system 13. The radiation projector 11 uses setting of direct dialing button 1101 and passes through coder 1102 to project different codes. The radiation receiver and automatic sound system 12 uses a single chip 1201 to control recording and emitting of sound IC 1202 as radiation receiver 1203 receives signal and goes through decoder 1204 to finally emit sound to visitors by means of earphones 1205. The recording system 13 uses PC 1301 and interface card 1302 for signal, starting of recording position, starting and ending of signal and hence, sound from sound card 1303 can be recorded into the IC 1202. The said system also uses multi-media computer and with the help of interface card 1302 and software, recordings can be saved into the WAV file. Primarily, recording position is sent to single chip 1201 through interface card 1302 and goes through sound card 1303 controlling program for emitting of WAV file and signal is thus sent to sound IC 1202. Signal for starting of recording is also sent to single chip 1201 through interface card 1302 and hence, single chip 1201 controls sound IC 1202 for recording. Relatively, PC will send an ending signal to single chip 1201 in order to stop recording of sound IC 1202.

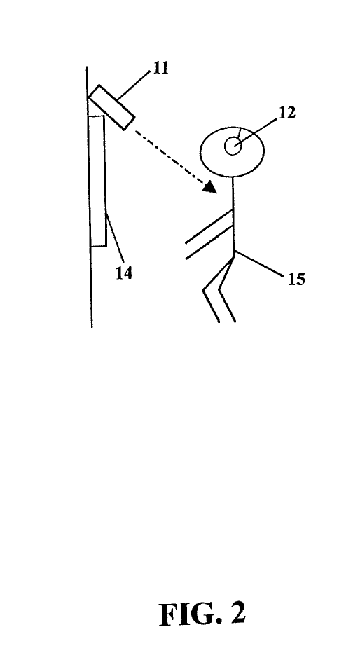

With reference to Fig. 2 showing the position of the radiation projector, said projector 11 is placed at the top of drawing 14 and projects signal in an inclined position such as visitors 15 equipped with a radiation receiver and automatic sound system 12 can receive signal in a certain range and thus listen to voice explanation. The five main functions of the present invention are as listed herewith:

1. Setting of direct dialing button project different radiation codes.

2. Radiation codes start emission of words recorded in the sound IC.

3. There is a button for repetition and one for pausing at visitor's choice.

4. An interface card is designed to control recording of sound IC.

5. Earphones or belt-speakers can be used to listen to sound voice.

The present invention described above can be used for introduction of objects exposed in art galleries or museums, animals in the zoo, plants in botanical gardens, and during factories or school visits.

Further, according to the present invention mentioned above, said system is extended to electrical appliances. For example, the sound emitting system can be installed in an air-conditioner such that settings are controlled by a remote control. The purpose is to attain automatic household appliances as the sound system notifies the user of actual room temperature, set temperature and status (high, sweep timer), being thus very convenient as the user does not have to look at the screen.

1. A kind of radiation controlling sound system mainly consisting of a radiation projector, a radiation receiver and automatic sound system, and a recording system as follows:
Said radiation projector uses set direct dialing button and passes through coder to project different codes;
Said radiation receiver and automatic sound system uses a single chip as center point to control recording and sound effect of sound IC: Radiation receiver receives signal and goes through decoder to finally emit sound to visitors by means of earphones;
Said recording system uses PC and interface card for signal, starting of recording position, starting and ending of signal and hence, sound from the sound card can be recorded into the IC. The system also uses multimedia computer and with the help of interface card and software, recording can be saved into the WAV file as characterized.

2. As described in claim 1 of “A radiation controlling sound system”, recording action is obtained by sending recording position to the single chip through the interface card and going through sound card controlling program for emitting of WAV file. Signal is thus sent to sound IC and signal for starting of recording is sent to the single chip controls the sound IC for recording. Relatively, the PC will send an ending signal to the single chip in order to stop recording of sound IC.
